(19) United States
(12) Patent Application Publication
(10) Pub. No.: US 2025/0139931 A1
(43) Pub. Date: May 1, 2025

(54) ATTRIBUTE IDENTIFICATION DEVICE AND ATTRIBUTE IDENTIFICATION METHOD

(71) Applicant: NEC Corporation, Tokyo (JP)

(72) Inventor: Mizuho KATAYAMA, Tokyo (JP)

(73) Assignee: NEC Corporation, Tokyo (JP)

(21) Appl. No.: 18/813,444

(22) Filed: Aug. 23, 2024

(30) Foreign Application Priority Data
Oct. 30, 2023 (JP) 2023-185157

(51) Int. Cl. G06V 10/40; G06V 10/25; G06V 10/74; G06V 10/75; G06V 10/82; G06V 40/10

(52) U.S. Cl. CPC G06V 10/40; G06V 10/25; G06V 10/751; G06V 10/759; G06V 10/761; G06V 10/82; G06V 40/10; G06V 2201/07

(57) ABSTRACT

The object detection means, when given a frame, derives a bounding box of a detection target object from within the frame based on a learning model that includes multiple layers, and defines output data of one layer in the learning model or the frame itself as a feature value of the frame. The feature value acquisition means acquires a feature value of the bounding box of an attribute identification target object from the feature value of the frame. The similarity degree determination means determines a similarity degree, and when the similarity degree is equal to or greater than a predetermined threshold, stops extracting the one or more attributes of the attribute identification target object, and identifies the one or more attributes of the attribute identification target object in the bounding box by diverting the one or more attributes corresponding to the feature value of the past bounding box.

### INCORPORATION BY REFERENCE

This application is based upon and claims the benefit of priority from Japanese patent application No. 2023-185157, filed on Oct. 30, 2023, the disclosure of which is incorporated herein in its entirety by reference.

### TECHNICAL FIELD

The present disclosure relates to an attribute identification device, an attribute identification method, and an attribute identification program.

### BACKGROUND ART

Methods for identifying attributes of objects in images are described in PTL 1 and NPL 1. PTL 1 describes identifying attributes from feature values related to motion lines. NPL 1 describes a technique for extracting attributes of objects from images.

For example, the color of clothing, type of clothing, hair color, and presence or absence of accessories are examples of attributes of a “person”. However, the attributes of a “person” are not limited to these. In addition, the items that are attributes vary depending on the type of object.

### CITATION LIST

### Patent Literature

PTL 1: Japanese Patent Application Laid-Open No. 2016-57998

### Non Patent Literature

NPL 1: Dangwei Li et al., “Multi-attribute Learning for Pedestrian Attribute Recognition in Surveillance Scenarios”, [retrieved on Sep. 14, 2023], Internet <URL: https://dangweili.github.io/misc/pdfs/acpr15-att.pdf>

### SUMMARY

The purpose of the present invention is to provide an attribute identification device, an attribute identification method, and an attribute identification program that can reduce the time required to identify one or more attributes.

An attribute identification device according to the present disclosure includes: a memory configured to store instructions; a processor configured to execute the instructions to: when given a frame, derive a bounding box of a detection target object from within the frame based on a learning model that includes multiple layers, and define output data of one layer in the learning model or the frame itself as a feature value of the frame; add a tracking ID to the bounding box; acquire a feature value of the bounding box of an attribute identification target object from the feature value of the frame; and extract one or more attributes of the attribute identification target object from the bounding box of the attribute identification target object; and a storage device that stores a combination of a frame ID, the tracking ID, the feature value of the bounding box of the attribute identification target object, and the one or more attributes of the attribute identification target object; wherein the processor determines a similarity degree between the feature value of the bounding box of the attribute identification target object and the feature value of a past bounding box corresponding to the tracking ID of the bounding box, and when the similarity degree is equal to or greater than a predetermined threshold, stops extracting the one or more attributes of the attribute identification target object, and identifies the one or more attributes of the attribute identification target object in the bounding box by diverting the one or more attributes corresponding to the feature value of the past bounding box.

An attribute identification method according to the present disclosure, implemented by a computer, includes, when given a frame, deriving a bounding box of a detection target object from within the frame based on a learning model that includes multiple layers, and defining output data of one layer in the learning model or the frame itself as a feature value of the frame; adding a tracking ID to the bounding box; acquiring a feature value of the bounding box of an attribute identification target object from the feature value of the frame; extracting one or more attributes of the attribute identification target object from the bounding box of the attribute identification target object; storing a combination of a frame ID, the tracking ID, the feature value of the bounding box of the attribute identification target object, and the one or more attributes of the attribute identification target object; determining a similarity degree between the feature value of the bounding box of the attribute identification target object and the feature value of a past bounding box corresponding to the tracking ID of the bounding box, and when the similarity degree is equal to or greater than a predetermined threshold, stopping extracting the one or more attributes of the attribute identification target object, and identifying the one or more attributes of the attribute identification target object in the bounding box by diverting the one or more attributes corresponding to the feature value of the past bounding box.

A computer-readable recording medium according to the present disclosure stores an attribute identification program, wherein the attribute identification program causes a computer to execute: an object detection process of, when given a frame, deriving a bounding box of a detection target object from within the frame based on a learning model that includes multiple layers, and defining output data of one layer in the learning model or the frame itself as a feature value of the frame; an object tracking process of adding a tracking ID to the bounding box; a feature value acquisition process of acquiring a feature value of the bounding box of an attribute identification target object from the feature value of the frame; an attribute extraction process of extracting one or more attributes of the attribute identification target object from the bounding box of the attribute identification target object; a storing process of storing a combination of a frame ID, the tracking ID, the feature value of the bounding box of the attribute identification target object, and the one or more attributes of the attribute identification target object, in a storage device; a similarity degree determination process of determining a similarity degree between the feature value of the bounding box of the attribute identification target object and the feature value of a past bounding box corresponding to the tracking ID of the bounding box, and when the similarity degree is equal to or greater than a predetermined threshold, stopping extracting the one or more attributes of the attribute identification target object, and identifying the one or more attributes of the attribute identification target object in the bounding box by diverting the one or more attributes corresponding to the feature value of the past bounding box.

### BRIEF DESCRIPTION OF THE DRAWINGS

FIG. 1 It depicts a block diagram showing an example configuration of an attribute identification device for the present disclosure.

FIG. 2 It depicts a schematic diagram showing an example of a bounding box identified in a frame.

FIG. 3 It depicts a schematic diagram showing an example of bounding boxes containing a common person, derived from three consecutive frames.

FIG. 4 It depicts a flowchart showing an example of the processing flow of the attribute identification device for the present disclosure.

FIG. 5 It depicts a flowchart showing an example of the processing flow of the attribute identification device for the present disclosure.

FIG. 6 It depicts a flowchart showing an example of the processing flow of the attribute identification device for the present disclosure.

FIG. 7 It depicts a schematic block diagram showing an example configuration of a computer related to the attribute identification device.

FIG. 8 It depicts a block diagram showing an overview of the attribute identification device for the present disclosure.

### EXAMPLE EMBODIMENT

The following is a description of the example embodiment of the present disclosure with reference to the drawings.

“Object detection” is an operation of deriving, based on a given frame, a bounding box of a detection target object, a score indicating the reliability of the bounding box, and a class indicating the type of the detection target object.

The “detection target object” is an object from which the bounding box, the score, and the class should be derived from a frame. For example, “person” and “vehicle” are examples of the detection target object. However, the detection target objects are not limited to these.

The “attribute identification target object” is an object whose one or more attributes (hereinafter referred to as attributes) should be identified among the detection target objects. For example, when the detection target objects are “person” and “vehicle” and the attributes should be identified for person, “person” corresponds to the attribute identification target object. Each of the detection target objects may also fall under the attribute identification target object.

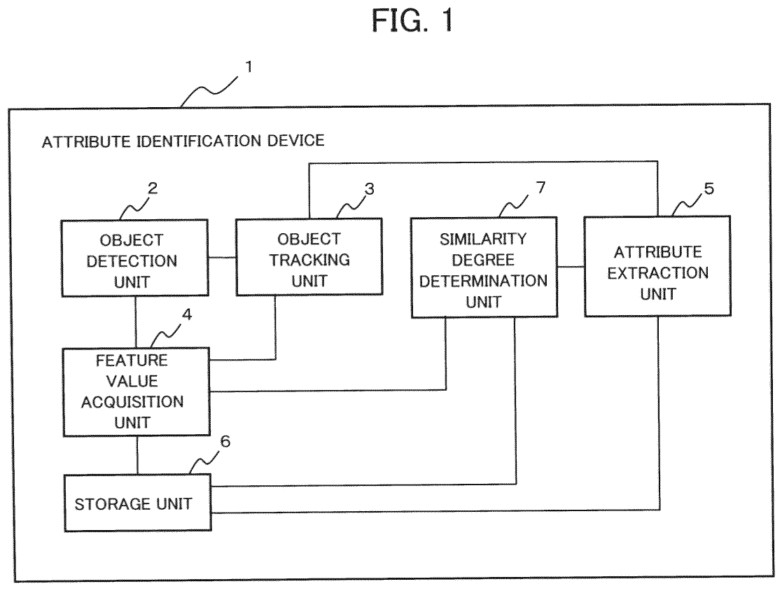

FIG. 1 is a block diagram showing an example configuration of an attribute identification device for the present disclosure. The attribute identification device 1 includes an object detection unit 2, an object tracking unit 3, a feature value acquisition unit 4, an attribute extraction unit 5, a storage unit 6, and a similarity degree determination unit 7.

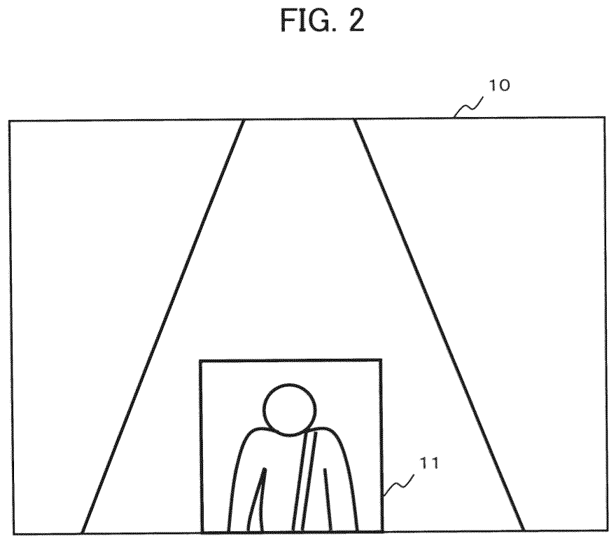

Given a frame, the object detection unit 2 derives the bounding box of the detection target object from within the frame based on a learning model that includes multiple layers. Specifically, based on the frame and the learning model, the object detection unit 2 derives the bounding box of the detection target object, the score indicating the reliability of the bounding box, and the class indicating the type of the detection target object. FIG. 2 is a schematic diagram showing an example of a bounding box identified in a frame. FIG. 2 shows bounding box 11 derived from frame 10. FIG. 2 also shows an example of a case in which only one person, the detection target object, is shown in frame 10. A frame ID is defined for a frame.

The learning model that includes multiple layers is, for example, a deep neural network, but the learning model is not limited to the deep neural network.

The object detection unit 2 also defines output data of one layer in the learning model or the given frame itself as a feature value of the frame. In other words, not only the output data of one layer obtained by sequentially applying layers to the frame, but also the result of applying a layer to the frame zero times (i.e., the frame itself) is included in the concept of the feature value of the frame. Examples of the output data of a layer include, but are not limited to, the results of convolution operations using the layer. The feature value of a frame is represented by a tensor.

When the multiple layers in the learning model are divided into the first half and the second half, it is preferable for the object detection unit 2 to determine the output data of the first half layer as the feature value of the frame. This is because the output data of the first half layer still contains spatial features and information on contours of the detection target object.

The object detection unit 2 inputs the derived bounding box, score and class to the object tracking unit 3.

The object detection unit 2 inputs the frame ID, the bounding box of the attribute identification target object, and the feature value of the frame to the feature value acquisition unit 4. The attribute identification target object is specified in advance by the user of the attribute identification device 1. The following is an example of a case in which the attribute identification target object is a person.

The object tracking unit 3 adds a tracking ID to the input bounding box. The object tracking unit 3 refers to previous bounding boxes and tracking IDs and adds a tracking ID to a bounding box so that bounding boxes containing a common detection target object have a common tracking ID.

The object tracking unit 3 also adds a new tracking ID to the bounding box of the newly appeared detection target object.

The bounding box, the score and the class derived by object detection unit 2, plus the tracking ID of the bounding box, is the information indicating the tracking result. The object tracking unit 3 may output the information indicating the tracking result to external parties.

The object tracking unit 3 inputs the bounding box of the attribute identification target object and its tracking ID to the attribute extraction unit 5.

The object tracking unit 3 inputs the tracking ID of the bounding box of the attribute identification target object to the feature value acquisition unit 4.

The feature value acquisition unit 4 acquires a feature value of the bounding box of the attribute identification target object from the feature values of the frame. The feature value of the bounding box of the attribute identification target object is also represented by a tensor. Specifically, the feature value acquisition unit 4 acquires the feature value of the bounding box by cutting out the part determined by the coordinates (position) of the bounding box from the feature value of the frame. In other words, the feature value of the bounding box is the data acquired by cutting out the part determined by the position of the bounding box from the feature value of the frame.

Furthermore, the feature value acquisition unit 4 converts the feature value (tensor) of the bounding box of the attribute identification target object into, for example, a matrix with a predetermined number of rows or a vector with a predetermined number of elements. Here, the case in which the feature value acquisition unit 4 converts the feature value of the bounding box of the attribute identification target object into a matrix with a predetermined number of rows will be used as an example.

The conversion result of the feature value of the bounding box can also be said to be the feature value of the bounding box.

The feature value acquisition unit 4 stores the combination of the frame ID, the conversion result of the feature value of the bounding box of the attribute identification target object, and the tracking ID of the bounding box in the storage unit 6.

The feature value acquisition unit 4 inputs the conversion result of the feature value of the bounding box of the attribute identification target object and the tracking ID of the bounding box to the similarity degree determination unit 7.

The attribute extraction unit 5 extracts attributes of the attribute identification target object from the bounding box of the attribute identification target object. The method of extracting attributes may be any known method. For example, the attribute extraction unit 5 may extract attributes from the bounding box of the attribute identification target object using the technique described in NPL 1.

However, the attribute extraction unit 5 extracts the attributes of the attribute identification target object from the bounding box of the attribute identification target object when the tracking ID of the bounding box is a new tracking ID or when the similarity degree determination unit 7 does not divert the attributes obtained in the past as the attributes of the attribute identification target object.

When the attributes of the attribute identification target object are extracted, the attribute extraction unit 5 refers to the tracking ID input from the object tracking unit 3, and adds the extracted attributes to the combination of the frame ID, the conversion result of the feature value of the bounding box of the attribute identification target object, and the tracking ID of the bounding box stored in the storage unit 6.

The storage unit 6 is a storage device that stores the combination of the frame ID, the tracking ID, the feature value of the bounding box of the attribute identification target object, and the attributes of that attribute identification target object. More specifically, the storage unit 6 stores the conversion result of the feature value as the feature value of the bounding box of the attribute identification target object.

The similarity degree determination unit 7 determines the similarity degree between the feature value of the bounding box of the attribute identification target object and the feature value of the past bounding box corresponding to the tracking ID of the bounding box. At this time, the similarity degree determination unit 7 has received the conversion result of the feature value of the bounding box of the attribute identification target object and the tracking ID of that bounding box from the feature value acquisition unit 4. The similarity degree determination unit 7 obtains the conversion result of the feature value of the past bounding box corresponding to that tracking ID from the storage unit 6. The two conversion results are represented by the matrix with the predetermined number of rows. Based on the conversion result of the feature value of the bounding box of the attribute identification target object input from the feature value acquisition unit 4 (the matrix with the predetermined number of rows) and the conversion result of the feature value of the past bounding box (the matrix with the predetermined number of rows), the similarity degree determination unit 7 obtains the CKA (Centered Kernel alignment). The similarity degree determination unit 7 then uses the CKA as the above similarity degree. The similarity degree obtained based on the two matrices is not limited to the CKA, and other values obtained based on the two matrices may be used as the above similarity degree. The past above is, for example, the most recent past (one previous frame), but is not limited to the most recent past.

The fact that the similarity degree is equal to or greater than a predetermined threshold means that the bounding box of the attribute identification target object and the past bounding box corresponding to the tracking ID of that bounding box are similar. Therefore, when the above similarity degree is equal to or greater than the predetermined threshold, then the similarity degree determination unit 7 stops the extraction of attributes by the attribute extraction unit 5 and identifies the attributes of the attribute identification target object in the current bounding box under focus by diverting the attributes corresponding to the feature value (more specifically, the conversion result of the feature value) of that past bounding box.

Then, the similarity degree determination unit 7 adds the identified attributes to the combination of the frame ID, the conversion result of the feature value of the bounding box of the attribute identification target object, and the tracking ID of the bounding box, which is stored in the storage unit 6.

When the similarity degree is less than the threshold value, the attribute extraction unit 5 extracts the attributes of the attribute identification target object from the bounding box of the attribute identification target object, as described above. Then, the attribute extraction unit 5 adds the extracted attributes to the combination of the frame ID, the conversion result of the feature value of the bounding box of the attribute identification target object, and the tracking ID of the bounding box, which is stored in the storage unit 6.

The object detection unit 2, the object tracking unit 3, the feature value acquisition unit 4, the attribute extraction unit 5, and the similarity degree determination unit 7 are realized, for example, by a CPU (Central Processing Unit) of a computer operating according to an attribute identification program. In this case, the CPU may read the attribute identification program from a program storage medium such as a program storage device of the computer, and operate as the object detection unit 2, the object tracking unit 3, the feature value acquisition unit 4, the attribute extraction unit 5, and the similarity degree determination unit 7 according to the attribute identification program.

The storage unit 6 is realized, for example, by a storage device in the computer described above.

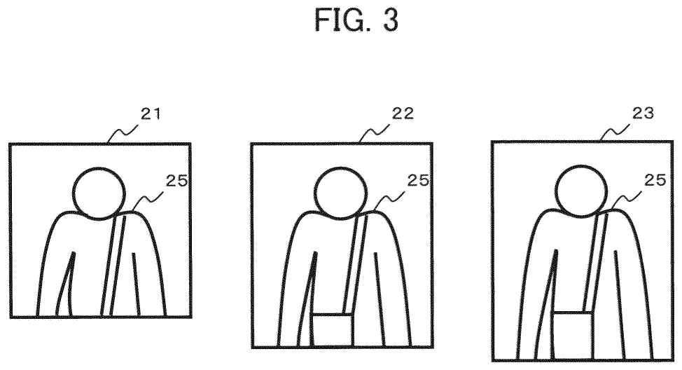

FIG. 3 is a schematic diagram showing an example of bounding boxes containing a common person, derived from three consecutive frames. Since the three bounding boxes 21, 22, and 23 contain a common person, a common tracking ID is added to the three bounding boxes 21, 22, and 23.

It is assumed that the bounding box 21 is the bounding box derived from the frame in which the person 25 first appeared. In this case, the object tracking unit 3 adds a new tracking ID to the bounding box 21. The object tracking unit 3 then inputs the bounding box 21 and its tracking ID to the attribute extraction unit 5. The object tracking unit 3 also inputs the tracking ID to the feature value acquisition unit 4.

The feature value acquisition unit 4 receives the frame ID, the bounding box 21, and the feature value of the frame from the object detection unit 2. The feature value acquisition unit 4 acquires the feature value of the bounding box 21 from the feature value of the frame and converts the feature value into the matrix with the predetermined number of rows. The feature value acquisition unit 4 stores the combination of the frame ID, the conversion result of the feature value of the bounding box 21, and the tracking ID of the bounding box 21 in the storage unit 6.

In this case, since the tracking ID of the bounding box 21 is a new tracking ID, the attribute extraction unit 5 extracts the attributes of the person 25 from the bounding box 21. The attribute extraction unit 5 then adds the extracted attributes to the combination of the frame ID, the conversion result of the feature value of the bounding box 21, and the tracking ID of the bounding box 21. As a result, the storage unit 6 stores the combination of the frame ID, the conversion result of the feature value of the bounding box 21, the tracking ID of the bounding box 21, and the attributes of the person 25.

It is assumed that a second frame is input and the bounding box 22 is derived from that frame. The bounding box 22 shows a person 25 bag. The object tracking unit 3 adds a tracking ID to the bounding box 22 that is common to the bounding box 21. The object tracking unit 3 then inputs the bounding box 22 and its tracking ID to the attribute extraction unit 5. The object tracking unit 3 also inputs the tracking ID to the feature value acquisition unit 4.

The feature value acquisition unit 4 receives the frame ID of the second frame, the bounding box 22, and the feature value of that frame from the object detection unit 2. The feature value acquisition unit 4 acquires the feature value of the bounding box 22 from the feature value of the frame and converts the feature value into the matrix with the predetermined number of rows. The feature value acquisition unit 4 stores the combination of the frame ID, the conversion result of the feature value of the bounding box 22, and the tracking ID of the bounding box 22 in the storage unit 6. The feature value acquisition unit 4 also inputs the conversion result of the feature value of the bounding box 22 and the tracking ID of the bounding box 22 to the similarity degree determination unit 7.

The similarity degree determination unit 7 obtains the conversion result of the feature value of the past bounding box 21 corresponding to that tracking ID from the storage unit 6. The similarity degree determination unit 7 obtains the CKA based on the conversion result of the feature value of the bounding box 22 and the conversion result of the feature value of the past bounding box 21. The similarity degree determination unit 7 then uses the CKA as the similarity degree between the feature value of the bounding box 22 and the feature value of the bounding box 21. In this example, it is assumed that this similarity degree is less than the predetermined threshold.

In this case, the attribute extraction unit 5 extracts the attributes of the person 25 from the bounding box 22. Then, the attribute extraction unit 5 adds the extracted attributes to the combination of the frame ID of the second frame, the conversion result of the feature value of the bounding box 22, and the tracking ID of the bounding box 22, including the tracking ID input from the object tracking unit 3. As a result, the storage unit 6 stores the combination of the frame ID of the second frame, the conversion result of the feature value of the bounding box 22, the tracking ID of the bounding box 22, and the attributes of the person 25.

It is assumed that a third frame is input and the bounding box 23 is derived from that frame. In bounding box 23, a person 25 bag is shown, as in bounding box 22. The object tracking unit 3 adds a tracking ID to the bounding box 23 that is common to the bounding boxes 21 and 22. The object tracking unit 3 then inputs the bounding box 23 and its tracking ID to the attribute extraction unit 5. The object tracking unit 3 also inputs the tracking ID to the feature value acquisition unit 4.

The feature value acquisition unit 4 receives the frame ID of the third frame, the bounding box 23, and the feature value of that frame from the object detection unit 2. The feature value acquisition unit 4 acquires the feature value of the bounding box 23 from the feature value of the frame and converts the feature value into the matrix with the predetermined number of rows. The feature value acquisition unit 4 stores the combination of the frame ID, the conversion result of the feature value of the bounding box 23, and the tracking ID of the bounding box 23 in the storage unit 6. The feature value acquisition unit 4 also inputs the conversion result of the feature value of the bounding box 23 and the tracking ID of the bounding box 23 to the similarity degree determination unit 7.

The similarity degree determination unit 7 obtains the conversion result of the feature value of the past bounding box 22 corresponding to that tracking ID from the storage unit 6. The similarity degree determination unit 7 obtains the CKA based on the conversion result of the feature value of the bounding box 23 and the conversion result of the feature value of the past bounding box 22. The similarity degree determination unit 7 then uses the CKA as the similarity degree between the feature value of the bounding box 23 and the feature value of the bounding box 22. In this example, it is assumed that this similarity degree is equal to or greater than the predetermined threshold.

In this case, the similarity degree determination unit 7 stops the extraction of attributes by the attribute extraction unit 5 and identifies the attributes of the person 25 in the current bounding box 23 by diverting the attributes corresponding to the conversion result of the feature value of the past bounding box 22. The similarity degree determination unit 7 then adds the identified attributes to the combination of the frame ID of the third frame, the conversion result of the feature value of the bounding box 23, and the tracking ID of the bounding box 23, including the tracking ID input from the feature value acquisition unit 4. As a result, the storage unit 6 stores the combination of the frame ID of the third frame, the conversion result of the feature value of the bounding box 23, the tracking ID of the bounding box 23, and the attributes of the person 25.

Thus, when the similarity degree between the feature value of the current bounding box and the feature value of the past bounding box is equal to or greater than the predetermined threshold, the similarity degree determination unit 7 stops the extraction of attributes by the attribute extraction unit 5 and identifies the attributes of the attribute identification target object in the current bounding box by diverting the attributes corresponding to the conversion result of the feature value of the past bounding box. Therefore, for one attribute identification target object, the attribute extraction unit 5 does not necessarily extract the attributes of the attribute identification target object in the bounding box every frame, but the similarity degree determination unit 7 diverts the attributes corresponding to the feature value of the past bounding box as the attributes corresponding to the current bounding box in some cases. In addition, the operation of diverting an already existing attributes as the current attributes does not take time. Thus, the time required to identify the attributes can be reduced.

The above explanation describes a case in which the feature value acquisition unit 4 converts the feature value (tensor) of the bounding box of the attribute identification target object into the matrix with the predetermined number of rows. In this case, the similarity degree determination unit 7 uses the CKA as the similarity degree between the feature value of the current bounding box and the feature value of the past bounding box.

The feature value acquisition unit 4 may convert the feature value (tensor) of the bounding box of the attribute identification target object into the vector with the predetermined number of elements. Even in this case, the feature value acquisition unit 4 stores the combination of the frame ID, the conversion result of the feature value of the bounding box of the attribute identification target object, and the tracking ID of the bounding box in the storage unit 6. The feature value acquisition unit 4 also inputs the conversion result of the feature value of the bounding box of the attribute identification target object and the tracking ID of the bounding box to the similarity degree determination unit 7.

Then, when the similarity degree determination unit 7 determines the similarity degree between the feature value of the bounding box of the attribute identification target object and the feature value of the past bounding box corresponding to the tracking ID of the bounding box, the similarity degree determination unit 7 may obtain cosine similarity degree between the conversion result (vector) of the feature value of the bounding box of the attribute identification target object and the conversion result (vector) of the feature value of the past bounding box. This cosine similarity degree may also be used as the similarity degree between the feature value of the current bounding box and the feature value of the past bounding box.

The same as above, except that the feature value acquisition unit 4 converts the feature value (tensor) the bounding box of the attribute identification target object into the vector with the predetermined number of elements, and that the similarity degree determination unit 7 obtains the cosine similarity degree as the similarity degree between the feature value of the current bounding box and the feature value of the past bounding box.

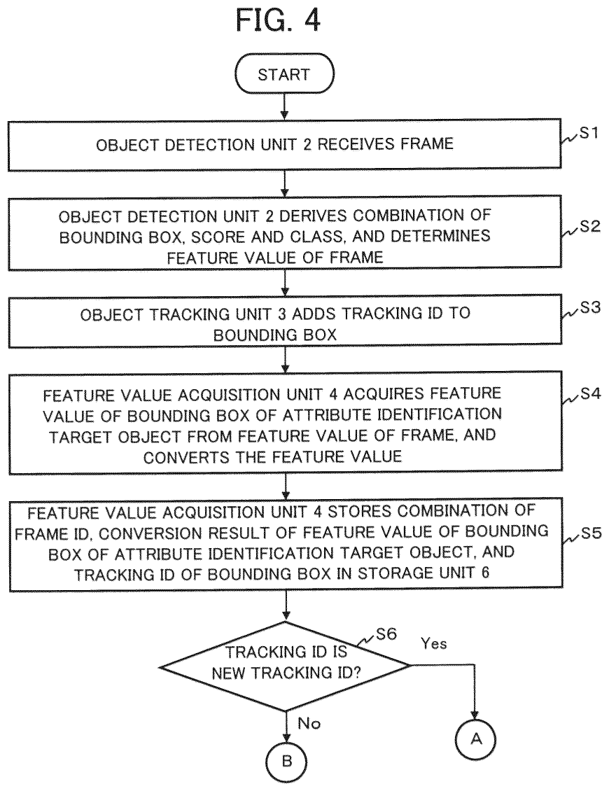

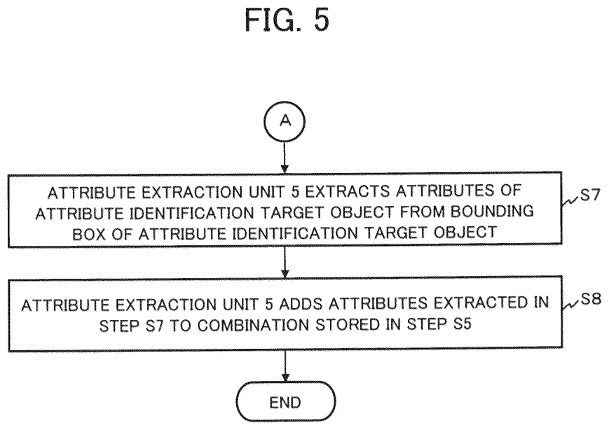

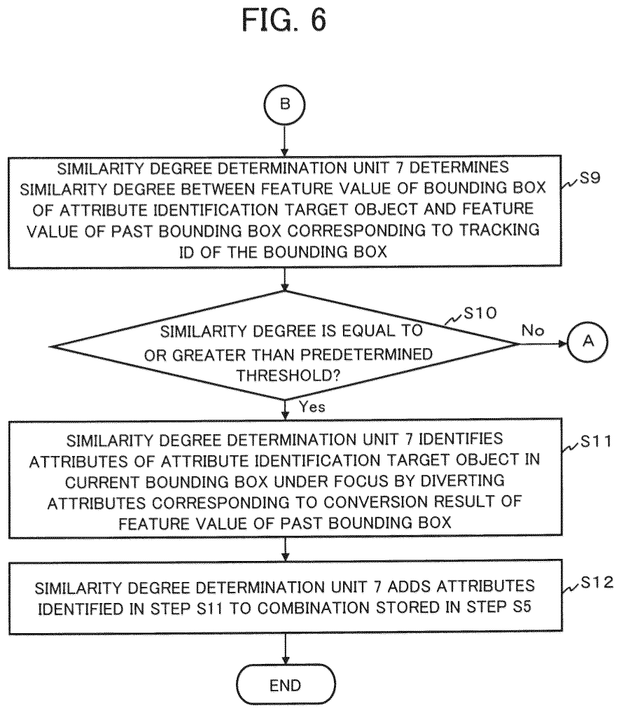

Next, the processing flow is described. FIG. 4, FIG. 5, and FIG. 6 are flowcharts showing an example of the processing flow of the attribute identification device for the present disclosure. Detailed explanations of matters already explained are omitted.

First, the object detection unit 2 receives one frame (step S1).

The object detection unit 2 then derives the combination of the bounding box, the score and the class based on the frame, and determines the feature value of the frame (step S2). The object detection unit 2 inputs the combination of the bounding box, the score and the class to the object tracking unit 3. The object detection unit 2 also inputs the frame ID, the bounding box of the attribute identification target object, and the feature value of the frame to the feature value acquisition unit 4.

Next to step S2, the object tracking unit 3 adds a tracking ID to the bounding box (step S3). The object tracking unit 3 inputs the bounding box of the attribute identification target object and its tracking ID to the attribute extraction unit 5. The object tracking unit 3 also inputs the tracking ID of the bounding box of the attribute identification target object to the feature value acquisition unit 4.

Next to step S3, the feature value acquisition unit 4 acquires the feature value of the bounding box of the attribute identification target object from the feature value of the frame, and converts the feature value (step S4).

Next, the feature value acquisition unit 4 stores the combination of the frame ID, the conversion result of the feature value of the bounding box of the attribute identification target object, and the tracking ID of the bounding box in the storage unit 6 (Step S5). The feature value acquisition unit 4 inputs the conversion result of the feature value of the bounding box of the attribute identification target object and the tracking ID of the bounding box to the similarity degree determination unit 7.

Next, the object tracking unit 3 determines whether or not the tracking ID added in step S3 is a new tracking ID (step S6).

When the tracking ID is a new tracking ID, move to step S7 (see FIG. 5) (Yes in step S6).

In step S7, the attribute extraction unit 5 extracts the attributes of the attribute identification target object from the bounding box of the attribute identification target object.

Next, the attribute extraction unit 5 adds the attributes extracted in step S7 to the combination stored in step S5 (step S8). At step S8, the process is terminated.

When the tracking ID is not a new tracking ID, move to step S9 (see FIG. 6) (No in step S6).

In step S9, the similarity degree determination unit 7 determines the similarity degree between the feature value of the bounding box of the attribute identification target object and the feature value of the past bounding box corresponding to the tracking ID of the bounding box.

Next, the similarity degree determination unit 7 determines whether or not the similarity degree is equal to or greater than the predetermined threshold (step S10).

When the similarity degree is less than the predetermined threshold (No in step S10), the aforementioned steps S7 and S8 (see FIG. 5) are executed and the process is terminated. Steps S7 and S8 have already been described, so they are omitted here.

When the similarity degree is equal to or greater than the predetermined threshold (Yes in step S10), move to step S11.

In step S11, the similarity degree determination unit 7 identifies the attributes of the attribute identification target object in the current bounding box under focus by diverting the attributes corresponding to the conversion result of the feature value of the past bounding box.

Then, the similarity degree determination unit 7 adds the attributes identified in step S11 to the combination stored in step S5 (step S12). The process ends at step S12.

When the next frame is sent, the attribute identification device 1 may repeat the operation from step S1 onward.

As mentioned above, for one attribute identification target object, the attribute extraction unit 5 does not necessarily extract the attributes of the attribute identification target object in the bounding box every frame, but the similarity degree determination unit 7 diverts the attributes corresponding to the feature value of the past bounding box as the attributes corresponding to the current bounding box in some cases. In addition, the operation of diverting an already existing attributes as the current attributes does not take time. Thus, the time required to identify the attributes can be reduced.

In the above example embodiment, the predetermined threshold to be compared to the similarity degree may be specified in advance by the user of the attribute identification device 1.

In the above example embodiment, the case in which the feature value acquisition unit 4 converts the feature value and stores the conversion result of the feature value in the storage unit 6 is described. It is also possible for the feature value acquisition unit 4 to store the pre-converted feature value in the storage unit 6 without converting the feature value. Then, when the similarity degree determination unit 7 determines the similarity degree between the feature value of the bounding box of the attribute identification target object and the feature value of the past bounding box corresponding to the tracking ID of the bounding box, the similarity degree determination unit 7 may convert the respective feature values into the matrix with the predetermined number of rows or the vector with the predetermined number of elements, and use the respective conversion results to obtain the CKA or the cosine similarity.

In the above example embodiment, the case in which the feature value acquisition unit 4 acquires the feature value of the bounding box of the attribute identification target object from the feature value of the frame is described. It is also possible for the feature value acquisition unit 4 to calculate the feature value of the bounding box of the attribute identification target object based on the frame.

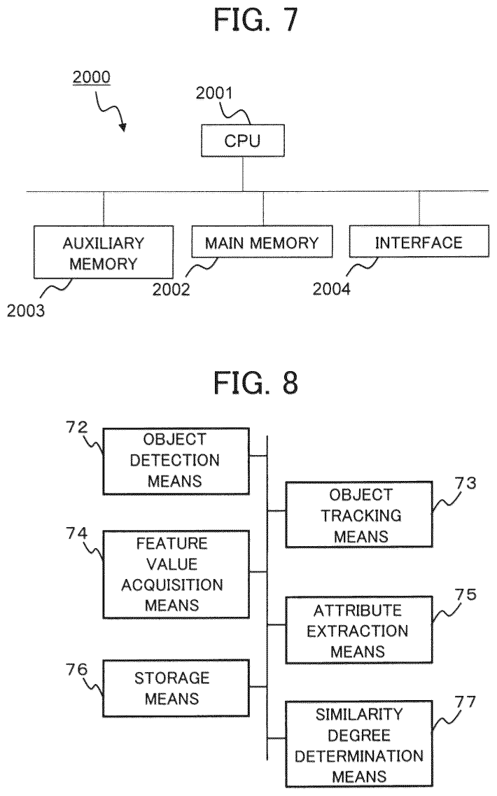

FIG. 7 is a schematic block diagram showing an example configuration of a computer related to the attribute identification device. The computer 2000, for example, includes a CPU 2001, a main memory 2002, an auxiliary memory 2003, and an interface 2004.

The attribute identification device of the present disclosure is realized, for example, by a computer 2000. The operation of the attribute identification device is stored in the auxiliary memory 2003 in the form of a program (attribute identification program). The CPU 2001 reads the program from the auxiliary memory 2003, expands the program in the main memory 2002, and executes the process described in the above example embodiment according to the program.

The auxiliary memory 2003 is an example of a non-transitory tangible medium. Other examples of non-transitory tangible media include magnetic disks, magneto-optical disks, CD-ROM (Compact Disk Read Only Memory), DVD-ROM (Digital Versatile Disk Read Only Memory), semiconductor memory, etc., connected via interface 2004.

Next, an overview of the attribute identification device for the present disclosure is described. FIG. 8 is a block diagram showing an overview of the attribute identification device for the present disclosure. The attribute identification device includes object detection means 72, object tracking means 73, feature value acquisition means 74, attribute extraction means 75, storage means 76, and similarity degree determination means 77.

When a frame is given, the object detection means 72 (e.g., the object detection unit 2) derives a bounding box of a detection target object from within the frame based on a learning model that includes multiple layers, and defines output data of one layer in the learning model or the frame itself as a feature value of the frame.

The object tracking means 73 (e.g., object tracking unit 3) adds a tracking ID to the bounding box.

The feature value acquisition means 74 (e.g., the feature value acquisition unit 4) acquires a feature value of the bounding box of an attribute identification target object from the feature value of the frame.

The attribute extraction means 75 (e.g., the attribute extraction unit 5) extracts one or more attributes of the attribute identification target object from the bounding box of the attribute identification target object.

The storage means 76 (e.g., the storage unit 6) stores a combination of a frame ID, the tracking ID, the feature value of the bounding box of the attribute identification target object, and the one or more attributes of the attribute identification target object.

The similarity degree determination means 77 (e.g., similarity degree determination unit 7) determines a similarity degree between the feature value of the bounding box of the attribute identification target object and the feature value of a past bounding box corresponding to the tracking ID of the bounding box, and when the similarity degree is equal to or greater than a predetermined threshold, stops extracting the one or more attributes of the attribute identification target object, and identifies the one or more attributes of the attribute identification target object in the bounding box by diverting the one or more attributes corresponding to the feature value of the past bounding box.

Such a configuration can reduce the time required to identify one or more attributes.

Calculating the attributes corresponding to each bounding box for each frame using the techniques described in PTL 1 and NPL 1 is computationally time-consuming.

According to the present disclosure, the time required to identify one or more attributes can be reduced.

The above example embodiment of the present invention may also be described as, but is not limited to, the following supplementary notes.

### (Supplementary Note 1)

An attribute identification device comprising:
object detection means for, when given a frame, deriving a bounding box of a detection target object from within the frame based on a learning model that includes multiple layers, and defining output data of one layer in the learning model or the frame itself as a feature value of the frame;
object tracking means for adding a tracking ID to the bounding box;
feature value acquisition means for acquiring a feature value of the bounding box of an attribute identification target object from the feature value of the frame;
attribute extraction means for extracting one or more attributes of the attribute identification target object from the bounding box of the attribute identification target object;
storage means for storing a combination of a frame ID, the tracking ID, the feature value of the bounding box of the attribute identification target object, and the one or more attributes of the attribute identification target object;
similarity degree determination means for determining a similarity degree between the feature value of the bounding box of the attribute identification target object and the feature value of a past bounding box corresponding to the tracking ID of the bounding box, and when the similarity degree is equal to or greater than a predetermined threshold, stopping extracting the one or more attributes of the attribute identification target object, and identifying the one or more attributes of the attribute identification target object in the bounding box by diverting the one or more attributes corresponding to the feature value of the past bounding box

### (Supplementary Note 2)

The attribute identification device according to supplementary note 1,
wherein when the multiple layers in the learning model are divided into a first half and a second half, the object detection means defines output data of the first half layer as the feature value of the frame.

### (Supplementary Note 3)

The attribute identification device according to supplementary note 1 or supplementary note 2,
wherein when determining the similarity degree between the feature value of the bounding box of the attribute identification target object and the feature value of the past bounding box corresponding to the tracking ID of the bounding box, the similarity degree determination means obtains CKA (Centered Kernel alignment) based on conversion results of converting the two feature values respectively into a matrix with a predetermined number of rows, uses the CKA as the similarity degree between the two feature values.

### (Supplementary Note 4)

The attribute identification device according to supplementary note 1 or supplementary note 2,
wherein when determining the similarity degree between the feature value of the bounding box of the attribute identification target object and the feature value of the past bounding box corresponding to the tracking ID of the bounding box, the similarity degree determination means obtains cosine similarity degree based on conversion results of converting the two feature values respectively into a vector with a predetermined number of elements, uses the cosine similarity degree as the similarity degree between the two feature values.

### (Supplementary Note 5)

An attribute identification method characterized in that,
a computer,
when given a frame, derives a bounding box of a detection target object from within the frame based on a learning model that includes multiple layers, and defines output data of one layer in the learning model or the frame itself as a feature value of the frame;
adds a tracking ID to the bounding box;
acquires a feature value of the bounding box of an attribute identification target object from the feature value of the frame;
extracts one or more attributes of the attribute identification target object from the bounding box of the attribute identification target object;
stores a combination of a frame ID, the tracking ID, the feature value of the bounding box of the attribute identification target object, and the one or more attributes of the attribute identification target object;
determines a similarity degree between the feature value of the bounding box of the attribute identification target object and the feature value of a past bounding box corresponding to the tracking ID of the bounding box, and when the similarity degree is equal to or greater than a predetermined threshold, stops extracting the one or more attributes of the attribute identification target object, and identifies the one or more attributes of the attribute identification target object in the bounding box by diverting the one or more attributes corresponding to the feature value of the past bounding box.

### (Supplementary Note 6)

A non-transitory computer-readable recording medium in which an attribute identification program is stored, wherein the attribute identification program causes a computer to execute:
an object detection process of, when given a frame, deriving a bounding box of a detection target object from within the frame based on a learning model that includes multiple layers, and defining output data of one layer in the learning model or the frame itself as a feature value of the frame;
an object tracking process of adding a tracking ID to the bounding box;
a feature value acquisition process of acquiring a feature value of the bounding box of an attribute identification target object from the feature value of the frame;
an attribute extraction process of extracting one or more attributes of the attribute identification target object from the bounding box of the attribute identification target object;
a storing process of storing a combination of a frame ID, the tracking ID, the feature value of the bounding box of the attribute identification target object, and the one or more attributes of the attribute identification target object, in a storage device;
a similarity degree determination process of determining a similarity degree between the feature value of the bounding box of the attribute identification target object and the feature value of a past bounding box corresponding to the tracking ID of the bounding box, and when the similarity degree is equal to or greater than a predetermined threshold, stopping extracting the one or more attributes of the attribute identification target object, and identifying the one or more attributes of the attribute identification target object in the bounding box by diverting the one or more attributes corresponding to the feature value of the past bounding box.

Some or all of the configurations described in supplementary notes 2 to 4, which are dependent on supplementary note 1 described above, can be dependent on supplementary note 5 and 6 by the same dependency relationship as supplementary notes 2 to 4. Furthermore, not limited to supplementary note 1, supplementary note 5, and supplementary note 6, some or all of the configurations described as supplementary notes can be similarly subordinated to various hardware, software, various recording means for recording software, or systems, to the extent not deviating from the example embodiments described above.

While the present disclosure has been particularly shown and described with reference to example embodiment thereof, the present disclosure is not limited to this example embodiment. It will be understood by those of ordinary skill in the art that various changes in from and details may be made therein without departing from the spirit and scope of the present disclosure as defined by the claims.

The present invention can be suitably applied to an attribute identification device that identifies the attributes of an attribute identification target object in frames.

What is claimed is:

1. An attribute identification device comprising:
a memory configured to store instructions;
a processor configured to execute the instructions to:
when given a frame, derive a bounding box of a detection target object from within the frame based on a learning model that includes multiple layers, and define output data of one layer in the learning model or the frame itself as a feature value of the frame;
add a tracking ID to the bounding box;
acquire a feature value of the bounding box of an attribute identification target object from the feature value of the frame; and
extract one or more attributes of the attribute identification target object from the bounding box of the attribute identification target object; and
a storage device that stores a combination of a frame ID, the tracking ID, the feature value of the bounding box of the attribute identification target object, and the one or more attributes of the attribute identification target object;
wherein the processor determines a similarity degree between the feature value of the bounding box of the attribute identification target object and the feature value of a past bounding box corresponding to the tracking ID of the bounding box, and when the similarity degree is equal to or greater than a predetermined threshold, stops extracting the one or more attributes of the attribute identification target object, and identifies the one or more attributes of the attribute identification target object in the bounding box by diverting the one or more attributes corresponding to the feature value of the past bounding box.

2. The attribute identification device according to claim 1,
wherein when the multiple layers in the learning model are divided into a first half and a second half, the processor defines output data of the first half layer as the feature value of the frame.

3. The attribute identification device according to claim 1,
wherein when determining the similarity degree between the feature value of the bounding box of the attribute identification target object and the feature value of the past bounding box corresponding to the tracking ID of the bounding box, the processor obtains CKA (Centered Kernel alignment) based on conversion results of converting the two feature values respectively into a matrix with a predetermined number of rows, uses the CKA as the similarity degree between the two feature values.

4. The attribute identification device according to claim 2,
wherein when determining the similarity degree between the feature value of the bounding box of the attribute identification target object and the feature value of the past bounding box corresponding to the tracking ID of the bounding box, the processor obtains CKA (Centered Kernel alignment) based on conversion results of converting the two feature values respectively into a matrix with a predetermined number of rows, uses the CKA as the similarity degree between the two feature values.

5. The attribute identification device according to claim 1,
wherein when determining the similarity degree between the feature value of the bounding box of the attribute identification target object and the feature value of the past bounding box corresponding to the tracking ID of the bounding box, the processor obtains cosine similarity degree based on conversion results of converting the two feature values respectively into a vector with a predetermined number of elements, uses the cosine similarity degree as the similarity degree between the two feature values.

6. The attribute identification device according to claim 2,
wherein when determining the similarity degree between the feature value of the bounding box of the attribute identification target object and the feature value of the past bounding box corresponding to the tracking ID of the bounding box, the processor obtains cosine similarity degree based on conversion results of converting the two feature values respectively into a vector with a predetermined number of elements, uses the cosine similarity degree as the similarity degree between the two feature values.

7. An attribute identification method, implemented by a computer, comprising:
when given a frame, deriving a bounding box of a detection target object from within the frame based on a learning model that includes multiple layers, and defining output data of one layer in the learning model or the frame itself as a feature value of the frame;
adding a tracking ID to the bounding box;
acquiring a feature value of the bounding box of an attribute identification target object from the feature value of the frame;
extracting one or more attributes of the attribute identification target object from the bounding box of the attribute identification target object;
storing a combination of a frame ID, the tracking ID, the feature value of the bounding box of the attribute identification target object, and the one or more attributes of the attribute identification target object;
determining a similarity degree between the feature value of the bounding box of the attribute identification target object and the feature value of a past bounding box corresponding to the tracking ID of the bounding box, and when the similarity degree is equal to or greater than a predetermined threshold, stopping extracting the one or more attributes of the attribute identification target object, and identifying the one or more attributes of the attribute identification target object in the bounding box by diverting the one or more attributes corresponding to the feature value of the past bounding box.

8. A non-transitory computer-readable recording medium in which an attribute identification program is stored, wherein the attribute identification program causes a computer to execute:
an object detection process of, when given a frame, deriving a bounding box of a detection target object from within the frame based on a learning model that includes multiple layers, and defining output data of one layer in the learning model or the frame itself as a feature value of the frame;
an object tracking process of adding a tracking ID to the bounding box;
a feature value acquisition process of acquiring a feature value of the bounding box of an attribute identification target object from the feature value of the frame;
an attribute extraction process of extracting one or more attributes of the attribute identification target object from the bounding box of the attribute identification target object;
a storing process of storing a combination of a frame ID, the tracking ID, the feature value of the bounding box of the attribute identification target object, and the one or more attributes of the attribute identification target object, in a storage device;
a similarity degree determination process of determining a similarity degree between the feature value of the bounding box of the attribute identification target object and the feature value of a past bounding box corresponding to the tracking ID of the bounding box, and when the similarity degree is equal to or greater than a predetermined threshold, stopping extracting the one or more attributes of the attribute identification target object, and identifying the one or more attributes of the attribute identification target object in the bounding box by diverting the one or more attributes corresponding to the feature value of the past bounding box.
